(19) United States
(12) Patent Application Publication
(10) Pub. No.: US 2020/0132891 A1
(43) Pub. Date: Apr. 30, 2020

(54) MICRO STRUCTURE, DISPLAY APPARATUS AND DISPLAY PANEL THEREOF

(71) Applicant: Wuhan China Star Optoelectronics Technology Co., Ltd., Wuhan, Hubei (CN)

(72) Inventor: Zefang DENG, Wuhan, Hubei (CN)

(21) Appl. No.: 15/752,774

(22) PCT Filed: Jan. 17, 2018
(86) PCT No.: PCT/CN2018/073056

§ 371 Date: Feb. 14, 2018

(30) Foreign Application Priority Data
Dec. 28, 2017 (CN) 201711457524.3

(51) Int. Cl. G02B 5/02; G02B 5/04; G06F 1/16

(52) U.S. Cl. CPC G02B 5/0231; G02B 1/11; G06F 1/1609; G02B 5/045

(57) ABSTRACT

The present invention provides a micro structure, a display apparatus and a display panel thereof. The display panel includes a display module and a cover glass disposed on the display module. A microstructure array is disposed on a surface of the cover glass facing away from the display module. The microstructure array includes a plurality of microstructure units arranged along a first direction, and each the microstructure unit includes a plurality of microstructures aligned in a second direction. Odd rows and even rows of the microstructure unit in the microstructure array both are aligned in the first direction. The arbitrary adjacent microstructure units in the microstructure array are offset in the second direction, by a predetermined shift distance. Through the microstructure array, reflection rate of cover glass surface is reduced, thus the display effect of a display panel is improved.

### RELATED APPLICATIONS

The present application is a National Phase of International Application Number PCT/CN2018/073056, filed Jan. 17, 2018, and claims the priority of China Application No. 201711457524.3, filed Dec. 28, 2017.

### FIELD OF THE DISCLOSURE

The present disclosure relates to a technical field of display, and more particularly, to a micro structure, a display apparatus and a display panel thereof.

### BACKGROUND

A display apparatus usually has a cover glass disposed on its surface. Due to reflection of the display cover glass, that ambient light shines on surface of the display apparatus would lead to reflection, when the display apparatus operating under intensive ambient light. When reflection rate is higher, the viewing effect is seriously impacted, even the display image is not clear.

To solve the problem, it requires performing anti-reflection treatment on the cover glass. At present, vapor depositing various anti-reflection films onto the cove glass is the most often method. Although anti-reflection films could reduce reflection rate of the cover glass surface, there is much confinement in the method: generally, vapor depositing single layer anti-reflection film onto the cover glass surface only can reduce reflection of single wavelength, and more obvious color shift phenomenon will appear from viewing the cover glass: furthermore, although vapor depositing multi-layer anti-reflection film onto the cover glass surface could reduce reflection rate within wavelength range of visible light (380 nm˜780 nm), complicated film layer structure would much raise process cost and its function stability is also reduced.

At present, with inspiration of moth eyes, people propose a method of making periodic microstructures on the cover glass surface, thus reflection rate of cover glass within wavelength range of visible light is reduced via the periodic microstructures. The surface of moth eyes has one microstructure layer of honeycomb shape, and feature size of the microstructure is hundred-nanometer order, less than wavelength of the incident light. Within the order of magnitude, the microstructure cannot be recognizable from light incident on the microstructure, such that refraction index continuously changes along the direction of depth, reducing reflection due to dramatical change in refraction index, further to reduce the reflection rate of material. 3D geometry and space distribution of “moth-eye” structure have large effect upon the reflection rate of cover glass. Thereby, it is required to provide a “moth-eye” structure making cover glass with lower reflection rate.

### SUMMARY

To solve the shortcoming of existing technology, the present invention provides a display apparatus and a display panel thereof, which can reduce the reflection rate of cover glass surface and improve the display effect of a display panel.

The present invention provides a concrete technology scheme, including: providing a microstructure array, wherein the microstructure array includes a plurality of microstructure units, each arranged along a first direction; wherein each the microstructure unit includes a plurality of microstructures aligned in a second direction and the first direction and the second direction are orthogonal to each other: wherein odd rows of the microstructure unit in the microstructure array are aligned in the first direction and even rows of the microstructure unit in the microstructure array are aligned in the first direction; wherein arbitrary adjacent microstructure units in the microstructure array are offset from each other in the second direction, by a predetermined shift distance.

The present invention further provides a display panel, and the display panel includes a display module and a cover glass disposed on the display module. A microstructure array is disposed on a surface of the cover glass facing away from the display module, and the microstructure array includes a plurality of microstructure units arranged along a first direction. Each the microstructure unit includes a plurality of microstructures aligned in a second direction. The first direction and the second direction are orthogonal to each other. Odd rows of the microstructure unit in the microstructure array are aligned in the first direction; even rows of the microstructure unit in the microstructure array are aligned in the first direction. Arbitrary adjacent microstructure units in the microstructure array are offset from each other in the second direction, by a predetermined shift distance.

Optionally, a cross-section shape of the microstructure is triangular.

Optionally, a shape of the microstructure projected onto the cover glass is a square, a rectangle, a circle or a triangle.

Optionally, a shape of the microstructure projected onto the cover glass is a square or a rectangle.

Optionally, a height of the microstructure is 500 nm˜1000 nm.

Optionally, a projection of the microstructure on the cover glass has a length of 400 nm˜600 nm both along the first direction and the second direction.

Optionally, in each the microstructure unit, all the distances between the arbitrary adjacent microstructures are equal.

Optionally, the predetermined shift distance is less than or equal to 50% of each the distances between the arbitrary adjacent microstructures in the microstructure units, and/or each the distance between the arbitrary adjacent microstructures in the microstructure units is 400 nm˜600 nm, and/or a distance between the arbitrary adjacent microstructure units in the microstructure array along the first direction is 400 nm˜600 nm.

The present invention further provides a display apparatus, and the display apparatus includes any of above-mentioned display panels.

A display panel provided by the present invention includes a cover glass with a microstructure array disposed on one its surface facing away from the display module. The microstructure array includes a plurality of microstructure units arranged along a first direction. The arbitrary adjacent microstructure units in the microstructure array are offset from each other in the second direction, by a predetermined shift distance. Through the microstructure array, reflection rate of cover glass surface is reduced, thus the display effect of a display panel is improved.

### BRIEF DESCRIPTION OF THE DRAWINGS

To more clearly illustrate embodiments of the application or technical solutions in the prior art, drawings to be used in the description of the embodiments of the application or the prior art will be briefly introduced hereinafter. Apparently, the drawings in the description below are merely some embodiments of the disclosure, a person skilled in the art can obtain other drawings according to these drawings without creative efforts. In the figures:

FIG. 1 is a schematic illustrating structure of a display apparatus:

FIG. 2 is a schematic illustrating structure of a display panel;

FIG. 3 is a schematic vertical view illustrating a display panel; and

FIG. 4 is a schematic illustrating spectra of a cover glass.

### DETAILED DESCRIPTION OF PREFERRED EMBODIMENTS

In order to understand the above objectives, features and advantages of the present disclosure more clearly, the present disclosure is described in detail below with references to the accompanying drawings and specific embodiments. However, there are many different forms to implement the present invention and the present invention should not be illustrated as being limited to the concrete embodiments, herein. On the contrary, those embodiments are provided to explain the principle and the application of the disclosure such that those skilled in the art may understand the various embodiments of the disclosure and the various modifications for specific expected application. In accompanying drawings, the same reference numerals will be used throughout to designate the same of like elements.

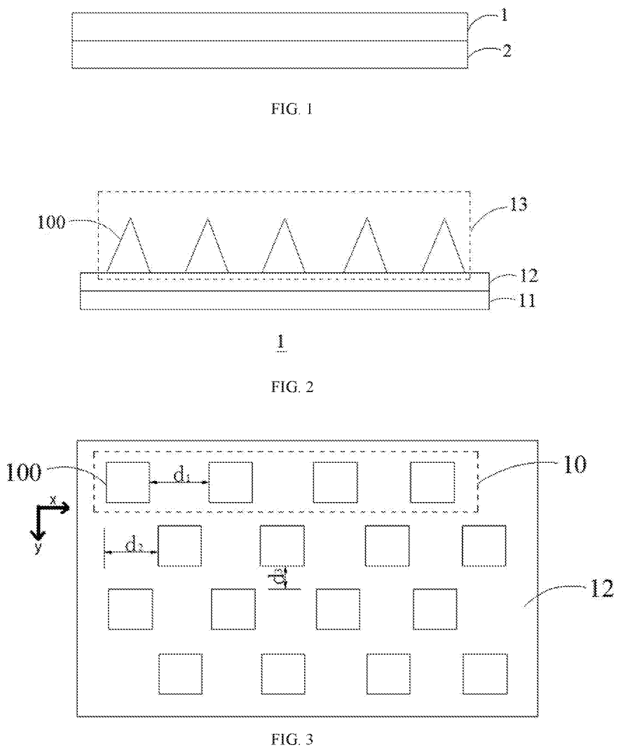

Referring to FIG. 1, FIG. 2 and FIG. 3, a display apparatus provided by the present embodiment includes a display panel 1 and a substrate 2, and the display panel 1 is disposed on the top of the substrate 2. The display 1 includes a display module 11 and a cover glass 12 disposed on the display module 11. A microstructure array 13 is disposed on a surface of the cover glass 12 facing away from the display module 11. The microstructure array 13 includes a plurality of microstructure units 10 arranged along a first direction; each the microstructure unit 10 includes a plurality of microstructures 100 aligned in a second direction. The first direction and the second direction are orthogonal to each other. Odd rows of the microstructure unit 10 are aligned in the first direction; even rows of the microstructure unit 10 are aligned in the first direction; further, the arbitrary adjacent microstructure units 10 are offset from each other in the second direction, by a predetermined shift distance. Herein, the first direction is y direction as shown in FIG. 2; the second direction is x direction as shown in FIG. 2. The display module 11 of the present embodiment may both be a liquid crystal display (LCD) module and an organic light emitting diode (OLED) module, that is, the display apparatus may both be LCDs and OLEDs.

Microstructure 100 of the present embodiment is nanometer order, and a cross-section shape of the microstructure may be triangular or trapezoidal. Herein, the cross-section refers to a cross-section of the microstructure 100 along the direction perpendicular to the x-axis and y-axis. Preferably, cross-section shape of the microstructure 100 is triangular.

A shape of the microstructure 100 projected onto the cover glass 12 is a square, a rectangle, a circle or a triangle, that is, a bottom shape of the microstructure 100 is a square, a rectangle, a circle or a triangle, and its corresponding form of the microstructure 100 is a regular square pyramid, a rectangular pyramid, a cone and a tetrahedron, respectively. Preferably, a shape of the microstructure 100 is a regular square pyramid or a rectangular pyramid. Because the refraction index of material surface continuously changes along the direction of depth, when a shape of the microstructure 100 is a regular square pyramid or a rectangular pyramid, the reflection due to dramatically change in refraction index in four lateral surfaces of a regular square pyramid or a rectangular pyramid is reduced.

A height of the microstructure 100 is 500 nm˜1000 nm, that is, a distance from an apex of the microstructure 100 to its bottom surface is 500 nm˜1000 nm. A projection of the apex of the microstructure 100 on its bottom surface coincides with the centroid of its bottom surface. A projection of the microstructure 100 on the cover glass 12 has a length of 400 nm˜600 nm both along the first direction and the second direction, that is, the bottom surface of the microstructure 100 has a length of 400 nm˜600 nm both along x direction and y direction. For example, a form of the microstructure 100 is a regular square pyramid, thus the bottom surface of the microstructure 100 has a length of 400 nm˜600 nm: a form of the microstructure 100 is a rectangular pyramid, thus the bottom surface of the microstructure 100 both has a length of 400 nm˜600 nm and a width of 400 nm˜600 nm: a form of the microstructure 100 is a cone, thus the bottom surface of the microstructure 100 has a diameter of 400 nm˜600 nm; a form of the microstructure 100 is a tetrahedron, thus the bottom surface of the microstructure 100 has a height of 400 nm˜600 nm.

As shown in FIG. 3, take the microstructure 100 of regular square pyramid form as an example. In each the microstructure unit 10, all the distances d1 between the arbitrary adjacent microstructures 100 are equal, and each the predetermined shift distance d₂ with respect to offset between the arbitrary adjacent microstructure units 10 along the second direction, i.e., x direction, is less than or equal to 50% of each the distance d₁ between the arbitrary adjacent microstructures 100 in the microstructure units 10, i.e., 0≤d₂≤d₁/2; wherein, each the distance d1 between the arbitrary adjacent microstructures 100 in the microstructure units 10 is 400 nm˜600 nm. In the microstructure array 13, a distance d₃ between the arbitrary adjacent microstructure units 10 along the first direction, i.e., y direction, is 400 nm˜600 nm.

The microstructure array 13 of the present embodiment is illustrated through following three concrete examples. The cover glass 12 may be a material of Quartz glass. The microstructure 100 is a regular square pyramid in the first example, and bottom surface of the regular square pyramid has a length of 450 nm and a height of 600 nm. The distance d₁ between the arbitrary adjacent regular square pyramids is 400 nm; the predetermined shift distance d₂ with respect to offset between the arbitrary adjacent microstructure units 10 along x direction is 200 nm; the distance d₃ between the arbitrary adjacent microstructure units 10 along y direction is 400 nm.

The microstructure 100 is a cone in the second example, and bottom surface of the cone has a diameter of 450 nm and a height of 600 nm. The distance dₜ between the arbitrary adjacent cones is 400 nm the predetermined shift distance d₂ with respect to offset between the arbitrary adjacent microstructure units 10 along x direction is 200 nm: the distance d₃ between the arbitrary adjacent microstructure units 10 along y direction is 400 nm.

The microstructure 100 is a tetrahedron in the third example, and bottom surface of the tetrahedron has a height of 450 nm and a height of the tetrahedron is 600 nm. The distance d₁ between the arbitrary adjacent tetrahedrons is 400 nm: the predetermined shift distance d₂ with respect to offset between the arbitrary adjacent microstructure units 10 along x direction is 200 nm: the distance d₃ between the arbitrary adjacent microstructure units 10 along y direction is 400 nm.

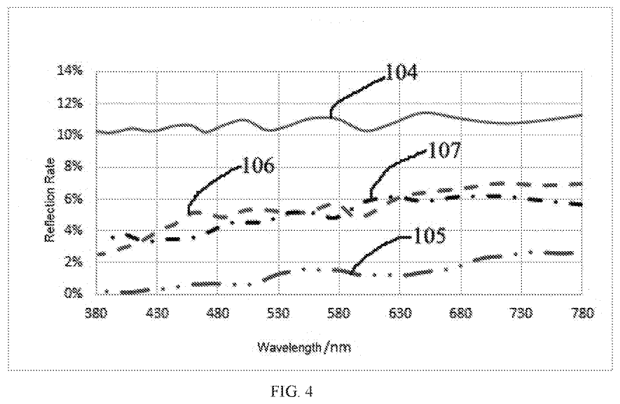

FIG. 4 is a schematic illustrating a curve of reflection rate against wavelength spectrum for the cover glass 12 in the three examples and for the cover glass 12 without the microstructure array 13. Wherein, a curve 104 represents reflection rate against wavelength spectrum, for the cover glass 12 without the microstructure array 13; a curve 105 represents reflection rate against wavelength spectrum in the first example: a curve 106 represents reflection rate against wavelength spectrum in the second example; and a curve 107 represents reflection rate against wavelength spectrum in the third example. An average reflection rate, for the cover glass 12 without the microstructure array 13, is 10.5%: Average reflection rates for the cover glass 12 of second and third example are 5.5%; an average reflection rate for the cover glass 12 of first example is 1.5%. A reflection rate of the cover glass 12, for the microstructure 100 with a form of a rectangular pyramid, is less than that of the cover glass 12, for the microstructure 100 with a form of a cone or a tetrahedron. In contrast with a reflection rate of the cover glass 12 without the microstructure array 13, it drops significantly when the microstructure 100 has the form of a cone or a tetrahedron. Therefore, the problem that display effect declines because of reflection from ambient light could be improved for adopting a display panel of the present embodiment as the display panel of portable display terminal, such as a cell phone and a tablet. The application prospect of the present embodiment is extensive in outdoors display area.

Above, with accompanying drawings, describes the embodiments of the present application, however the present application is not limited to above specific embodiments. The above-mentioned specific implementations are merely illustrative and cannot be construed as a limitation. Those skilled in the art can make numerous modifications without departing from the gist of the method and the scope of the claims, which all belong to the scope of the present disclosure.

What is claimed is:

1. A microstructure comprising:
a plurality of microstructure units, arranged along a first direction;
wherein each the microstructure unit includes a plurality of microstructures aligned in a second direction, the first direction and the second direction are orthogonal to each other;
wherein odd rows of the microstructure unit in the microstructure array are aligned in the first direction, even rows of the microstructure unit in the microstructure array are aligned in the first direction; and
wherein the arbitrary adjacent microstructure units in the microstructure array are offset from each other in the second direction, by a predetermined shift distance.

2. A display panel comprising a display module and a cover glass disposed on the display module;
wherein a microstructure array is disposed on a surface of the cover glass facing away from the display module, the microstructure array includes a plurality of microstructure units arranged along a first direction, each the microstructure unit includes a plurality of microstructures aligned in a second direction, the first direction and the second direction are orthogonal to each other; and
wherein odd rows of the microstructure unit in the microstructure array are aligned in the first direction, even rows of the microstructure unit in the microstructure array are aligned in the first direction, the arbitrary adjacent microstructure units in the microstructure array are offset from each other in the second direction, by a predetermined shift distance.

3. The display panel according to claim 2, wherein a cross-section shape of the microstructure is triangular.

4. The display panel according to claim 3, wherein a shape of the microstructure projected onto the cover glass is a square, a rectangle, a circle or a triangle.

5. The display panel according to claim 4, wherein a shape of the microstructure projected onto the cover glass is a square or a rectangle.

6. The display panel according to claim 3, wherein a height of the microstructure is 500 nm˜1000 nm.

7. The display panel according to claim 6, wherein a projection of the microstructure on the cover glass has a length of 400 nm˜600 nm both along the first direction and the second direction.

8. The display panel according to claim 2, wherein in each the microstructure unit, all the distances between the arbitrary adjacent microstructures are equal.

9. The display panel according to claim 3, wherein in each the microstructure unit, all the distances between the arbitrary adjacent microstructures are equal.

10. The display panel according to claim 4, wherein in each the microstructure unit, all the distances between the arbitrary adjacent microstructures are equal.

11. The display panel according to claim 8, wherein the predetermined shift distance is less than or equal to 50% of each the distances between the arbitrary adjacent microstructures in the microstructure units, and/or each the distance between the arbitrary adjacent microstructures in the microstructure units is 400 nm˜600 nm, and/or a distance between the arbitrary adjacent microstructure units in the microstructure array along the first direction is 400 nm˜600 nm.

12. A display apparatus comprising a display panel, wherein the display panel includes a display module and a cover glass disposed on the display module;
wherein a microstructure array is disposed on a surface of the cover glass facing away from the display module, the microstructure array includes a plurality of microstructure units arranged along a first direction, each the microstructure unit includes a plurality of microstructures aligned in a second direction, the first direction and the second direction are orthogonal to each other; and
wherein odd rows of the microstructure unit in the microstructure array are aligned in the first direction, even rows of the microstructure unit in the microstructure array are aligned in the first direction, the arbitrary adjacent microstructure units in the microstructure array are offset from each other in the second direction, by a predetermined shift distance.

13. The display apparatus according to claim 12, wherein a cross-section shape of the microstructure is triangular.

14. The display apparatus according to claim 13, wherein a shape of the microstructure projected onto the cover glass is a square, a rectangle, a circle or a triangle.

15. The display apparatus according to claim 14, wherein a shape of the microstructure projected onto the cover glass is a square or a rectangle.

16. The display apparatus according to claim 13, wherein a height of the microstructure is 500 nm˜1000 nm.

17. The display apparatus according to claim 16, wherein a projection of the microstructure on the cover glass has a length of 400 nm˜600 nm both along the first direction and the second direction.

18. The display apparatus according to claim 12, wherein in each the microstructure unit, all the distances between the arbitrary adjacent microstructures are equal.

19. The display apparatus according to claim 13, wherein in each the microstructure unit, all the distances between the arbitrary adjacent microstructures are equal.

20. The display apparatus according to claim 18, wherein the predetermined shift distance is less than or equal to 50% of each the distances between the arbitrary adjacent microstructures in the microstructure units, and/or each the distance between the arbitrary adjacent microstructures in the microstructure units is 400 nm˜600 nm, and/or a distance between the arbitrary adjacent microstructure units in the microstructure array along the first direction is 400 nm˜600 nm.
